(19) United States
(12) Patent Application Publication
(10) Pub. No.: US 2004/0102191 A1
(43) Pub. Date: May 27, 2004

(54) Communications system using high altitude relay platforms

(76) Inventors: Nelson D. Pewitt, San Diego, CA (US); David L. Wander, Winter Haven, FL (US)

Correspondence Address: NEIL K. NYDEGGER, NYDEGGER & ASSOCIATES, 348 Olive Street, San Diego, CA, 92103, US

(21) Appl. No.: 10/302,579

(22) Filed: Nov. 22, 2002

(51) Int. Cl. H04Q 7/20

(52) U.S. Cl. 455/431; 455/430; 455/429; 455/427

(57) ABSTRACT

A communications system includes a single stage, turbocharged, piston-powered aircraft that is positioned to fly in the lower stratosphere (41,000 ft.). A first link for the system is established between the aircraft and a subscriber on the ground, and a second link is established between the aircraft and a telecommunications base station. With the aircraft in position, communications between the subscriber and another party is then established over the first and second links, and through the base station.

### FIELD OF THE INVENTION

The present invention pertains generally to communications systems. More particularly, the present invention pertains to telecommunications systems that employ an airborne communications link. The present invention is particularly, but not exclusively, useful as an airborne communications link that is economically established by using a single stage, turbocharged, piston-powered aircraft which is flown in the lower stratosphere at an altitude of approximately forty-one thousand feet.

### BACKGROUND OF THE INVENTION

In addition to speed, reliability and sustainability, commercial communications systems need to be economical. Apart from the other considerations, the economics of installing a communications system is often the determinative factor in deciding whether to proceed. A consequence of this is that many areas of the world today, do not have an effective communications infrastructure. In particular, this is so in remote, isolated or hard-to-access locations, where terrestrial solutions are cost prohibitive.

For an airborne solution, rather than a terrestrial solution, the economics involved rely primarily on the airborne platform (vehicle) that is used to carry the communications payload aloft. Many potential airborne platforms exist, and have been considered for this purpose. For example, U.S. Pat. No. 6,061,562 which issued to Martin et al. for an invention entitled “Wireless Communication Using an Airborne Switching Node” discloses a communication system that includes an airborne communications link. Typical of presently proposed systems, however, the disclosure in this U.S. patent considers stratospheric flight by aircraft well above the tropopause (e.g. between 52,000 and 60,000 feet). Vehicles (aircraft) that can effectively operate at such altitudes are not necessarily economical for implementing communications systems that employ airborne relay techniques. As noted by commentators, “. . . it remains to be demonstrated that placing a platform at stratospheric altitude and “fixing” it reliably above the coverage area is possible, and that it can be done in a cost-effective, safe, and sustained manner.” (see Djuknic et al. “Establishing Wireless Communications Services via High-Altitude Aeronautical Platforms: A Concept Whose Time Has Come?” IEEE Communications Magazine, September 1997)

As indicated above, the airborne platform (vehicle, aircraft) that is used for an airborne communications link will profoundly affect the commercial economics of the overall system. Ideally, such a platform can fly, or be positioned, above normal airline traffic routes. Further, such a platform should be capable of avoiding most weather. These requirements effectively dictate that the platform be capable of operation above the tropopause (i.e. in the stratosphere). Further, these requirements also effectively preclude the use of tethered platforms. Consequently, conventional aircraft that only operate economically below the tropopause are effectively precluded from consideration. On the other hand, vehicles that are specifically designed for stratospheric flight are most economically operated only when flown well above the tropopause. A consequence here is the creation of a gap in the lower stratosphere (i.e. around 40,000 feet) where sustained, economical flight operations have not been thoroughly considered in the context of a communications system.

The fact that an airborne platform does not need speed to be effectively used in a communications system is a consideration. The fact the platform does not need a high payload miles capability is also a consideration. What is really important, however, is that the airborne platform be capable of on-station endurance with the minimum fuel consumption required for safe flight operations. On balance, in comparison with turbine-powered aircraft, piston-powered aircraft are better suited for slow-flight operations. For high altitude operations, however, piston-powered aircraft require turbocharging. Heretofore, conventional thinking has been that such turbocharging requires use of the more expensive multi-stage turbochargers.

In light of the above, it is an object of the present invention to provide a system and method for establishing a link for a communications system which economically uses a single stage, turbocharged, piston-powered aircraft flying in the lower stratosphere. Another object of the present invention is to provide a system and method for establishing a link for a communications system which services remote, isolated, hard-to-access areas where there is low subscriber density. Still another object of the present invention is to provide a system and method for establishing a link for a communication system that is easy to implement, simple to use, and comparatively cost effective.

### SUMMARY OF THE INVENTION

In accordance with the present invention, an economical communications system for transferring signals between separated ground-based stations, in a substantially rural environment, uses an airborne platform that is positioned in the lower stratosphere. Importantly, this airborne platform is a single stage, turbocharged, piston-powered aircraft. The aircraft may be either manned, or un-manned, and it may be either a single engine or a multi-engine aircraft. The economical aspects of the present invention are realized by using an airborne platform that is reliable in sustained operations above airline traffic and above most weather. For the present invention the preferred flight altitude is approximately forty-one thousand feet.

On-board the aircraft, the communications system payload includes at least one spot beam antenna. There may, of course, be more than one such antenna and, preferably, around six spot beam antennas will be used. A first link in the communications system is established between a subscriber on the ground and one of the spot beam antennas on the aircraft. Specifically, this first link is used for transferring signals between a first ground-based station (i.e. a subscriber) and the airborne platform. As envisioned for the present invention, this first link will use a carrier wave in a first frequency range that, preferably, includes radio frequencies (RF) between 1,850 MHz and 1,910 MHz.

The airborne payload also includes an airborne microwave antenna that is used for establishing a second link in the communications system. For this second link, the airborne microwave antenna is mounted on the airborne platform to transfer signals between the platform and a second ground-based station (i.e. a base station). As envisioned for the present invention, this second link will use a carrier wave in a second frequency range that, preferably, includes microwave (MW) frequencies between 3.7 GHz and 18 GHz.

An important component of the present invention is a communications relay unit that is carried on-board the aircraft. Specifically, the relay unit accomplishes two general tasks. For one, the relay unit is used for converting the signal carrier frequencies between the first frequency range and the second frequency range. For another, it is used for transferring the signal between the spot beam antenna in the first link and the airborne antenna in the second link. To do this transfer, the relay unit includes a stage for off-setting frequencies on the second link. Specifically, this is done to match each spot beam antenna on the aircraft with a transceiver at a base station on the ground.

At a fixed location on the ground, such as at the airport where the aircraft is based, a base station is established for the communications system of the present invention. This base station includes: an interface with a public switched telephone network (PSTN), or with some other similar type network, that connects with various parties on the ground; a base antenna for establishing microwave (MW) communications with the aircraft, and a plurality of transceivers that interconnect the PSTN, or other network, with the base antenna. The base station may also include a stage for off-setting frequencies to match each transceiver at the base station with a spot beam antenna on the aircraft.

In operation, a subscriber in a remote area (i.e. rural environment) directly communicates signals between his/her ground station and the airborne aircraft. This is done using a radio frequency (RF) carrier (i.e. first link). During this communication, a control channel in the aircraft's relay unit can be used for varying the signals to compensate for movement of the platform. In the aircraft the signals are then appropriately converted in frequency, and transferred between a spot beam antenna (first link) and a microwave antenna (second link) for transmissions to/from the base station. At the base station, the signals are processed by signal processing equipment, such as used in a conventional wireless cellular network.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic view of a communications system showing a deployment of the various components of the present invention; and

FIG. 2 is a schematic view of the electronic components of the present invention that are carried aloft in the payload of the airborne platform that is used for the present invention and the electronic components that are used at a base station.

### DESCRIPTION OF THE PREFERRED EMBODIMENTS

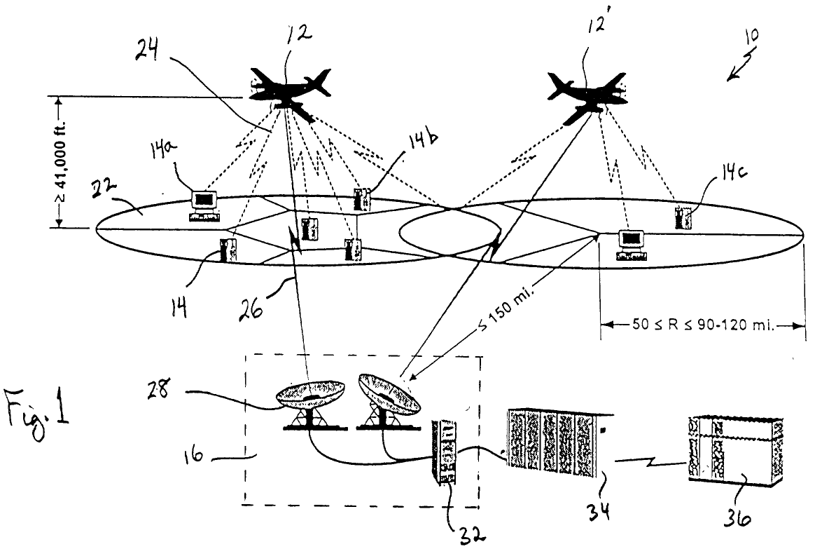

Referring initially to FIG. 1 a communications system incorporating a stratospheric airborne link for transferring signals between ground-based stations is shown and generally designated 10. As shown, the system 10 includes at least one aerial vehicle 12, and possibly more, in operation at any one time. The aerial vehicles 12 and 12′ shown in FIG. 1 are only exemplary. Regardless how many aerial vehicles 12 are in operation for the system 10, each aerial vehicle 12 is used to establish respective communications links between individual subscribers 14 and a central ground station 16 (subscribers 14a-c are exemplary).

An important aspect of the system 10 is the aerial vehicle 12 that is used In detail, the aerial vehicle 12 is intended to be a piston-powered aircraft having a single stage, turbocharged engine, or engines. Further, the turbocharger on the engine(s) of aerial vehicle 12 preferably operates with a compression ratio of approximately 6.0:1. Flight envelope calculations indicate that an aerial vehicle 12 with this configuration is capable of loitering in the lower stratosphere (e.g. at around forty-one thousand: 41,000 feet) for extended periods of time. As intended for the present invention, aerial vehicle 12 must be capable of sustained flight above commercial traffic, and above most weather systems. It is envisioned for the system 10 that the aerial vehicle 12 may either be manned, or unmanned. In the case of a manned aircraft, the system 10 will include a demand oxygen system on-board the aerial vehicle 12.

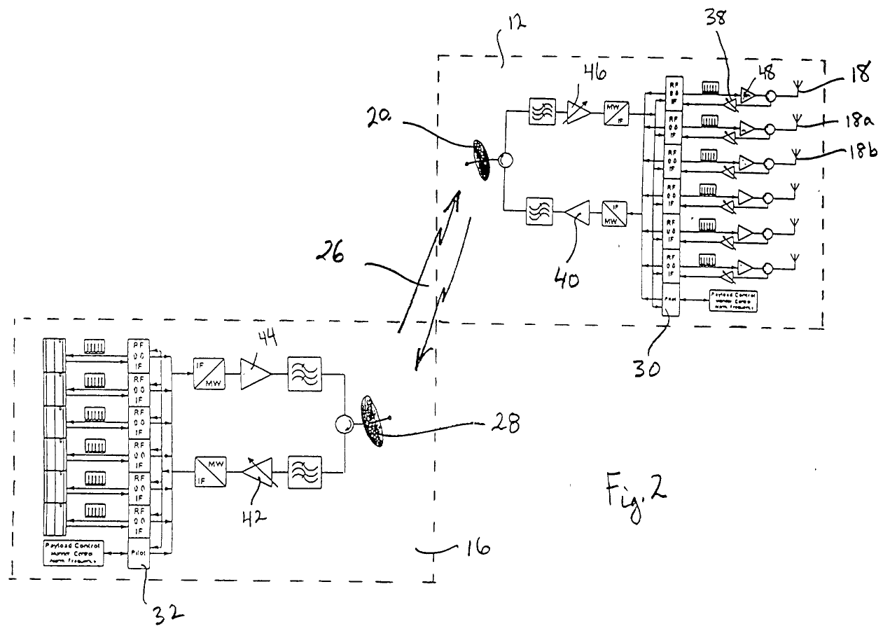

In FIG. 2 it is shown that the aerial vehicle 12 includes in its payload, a plurality of spot beam antennas 18 (antennas 18a and 18b are exemplary) as well as an airborne antenna 20. As shown in FIG. 1, the plurality of antennas 18 that are on-board the aerial vehicle 12 are intended to collectively service a respective plurality of subscribers 14. Specifically, these subscribers 14 will be located within a determinable footprint 22 (area) below the orbit of the aerial vehicle 12. As indicated in FIG. 1, the footprint 22 will be generally circular, and will have a radius that is in a range between about fifty miles to one hundred and twenty miles (i.e. 50-120 miles). More specifically, and using the subscriber 14 shown in FIG. 1 as an example, a communications link 24 can be established between the spot beam antenna 18 on-board the aerial vehicle 12 and the subscriber 14 on the ground. Communications back to the ground station 16 is then established over a communication link 26 that goes between the antenna 20 on-board the aerial vehicle 12 and an antenna 28 at the ground station 16.

Although many different communications schemes can be used for the system 10, it is preferred that the link 24 between a subscriber 14 and the aerial vehicle 12 use a frequency range that includes radio (RF) frequencies between 1,850 MHz and 1,910 MHz. On the other hand, it is also preferred that the link 26 between the aerial vehicle 12 and the ground station 16 use a frequency range that includes microwave (MW) frequencies between 3.7 GHz and 18 GHz. The change from one frequency range to another is accomplished in the aerial vehicle 12 by a relay/conversion unit 30, and the change back to the original frequency range is accomplished at the ground station 16 by another relay/conversion unit 32. Then, as shown, communication signals can be passed from the ground station 16 to a wireless switch 34 and on to a public switched telephone network (PSTN) 36, or to some similar type communications network. Alternatively, the communication can be passed from the ground station 16 back to another aerial vehicle 12 (e.g. aerial vehicle 12′) and from there to another subscriber 14 (e.g. subscriber 14c).

In detail, a communication connection between a subscriber 14 on the ground, from inside the footprint 22, and the ground station 16 (most likely outside the footprint 22), is best discussed with reference to FIG. 2. To begin, the subscriber 14 connects with a spot beam antenna 18 on the aerial vehicle 12 over the communications link 24. The communication signal is then sent through a low noise amplifier (LNA) 38 to the relay/conversion unit 30 onboard the aerial vehicle 12. There it is converted from a radio frequency (RF) signal into an intermediate frequency (IF) signal. The communication signal is then converted from the IF signal into a micro-wave (MW) signal and this MW signal is then sent from the relay/conversion unit 30 through a multi-carrier linear power amplifier (MCLPA) 40. After leaving the MCLPA 40, the MW signal is transmitted from the airborne antenna 20, via the communications link 26, to the antenna 28 at the ground station 16. The communication signal is then passed through LNA 42 and to the relay conversion unit 32 where it is appropriately converted for further transmission through the wireless switch 34 to the PSTN 36, or some similar type network.

For communications from the ground station 16 to a subscriber 14, a communications signal is first sent to the ground station 16. At the ground station 16, it is passed through the relay/conversion unit 32, and through the MCLPA 44 for transmission as a MW signal from the antenna 28 onto communications link 26. This communications signal is then received by the airborne antenna 20, passed through the LNA 46; and converted into an IF signal. As an IF signal, the signal is sent through the relay/conversion unit 30 for conversion into an RF signal. This RF signal is then passed through the MCLPA 48 and transmitted by the spot beam antenna 18 via communications link 24 to the subscriber 14 on the ground.

While the particular Communications System Using High Altitude Relay Platforms as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A communications system for transferring signals between ground-based stations, said system having a stratospheric airborne link which comprises:
an airborne platform positioned at a predetermined altitude in the stratosphere, wherein said platform is a single stage, turbocharged, piston-powered aircraft;
at least one spot beam antenna mounted on said platform for sending a signal between a first ground-based station and said platform using a carrier in a first frequency range;
an airborne antenna mounted on said platform for passing said signal between said platform and a second ground-based station using a carrier in a second frequency range; and
a communications relay unit mounted on said platform for converting carrier frequencies for said signal between said first frequency range and said second frequency range, and for transferring said signal between said spot beam antenna and said airborne antenna to establish communications between said first and second ground-based stations.

2. A system as recited in claim 1 wherein said predetermined altitude is approximately forty-one thousand feet.

3. A system as recited in claim 1 wherein said aircraft is a manned vehicle.

4. A system as recited in claim 1 wherein said aircraft has a turbocharger with a compression ratio of approximately 6.0:1.

5. A system as recited in claim 1 wherein said first frequency range includes radio (RF) frequencies between 1,850 MHz and 1.910 MHz, and wherein said second frequency range includes microwave (MW) frequencies between 3.7 GHz and 18 GHz.

6. A system as recited in claim 1 wherein said relay unit comprises:
a stage for off-setting frequencies to match each said spot beam antenna on said platform with a transceiver; and
a control channel for varying a power level of said signal in said first frequency range to compensate for movement of said platform.

7. A system as recited in claim 1 wherein said first ground station is a system subscriber.

8. A system as recited in claim 1 further comprising a base station which comprises:
a base antenna for communication with said airborne antenna on said platform;
a stage for off-setting frequencies to match each said spot beam antenna on said platform with a transceiver at said base ground station; and
a control channel for making adjustments to frequencies in said second frequency range.

9. A system as recited in claim 8 wherein said second ground-based station is connected to said base station and is a public switched telephone network.

10. A communications system for transferring signals between ground-based stations which comprises:
a first link for sending a signal between a first ground-based station and an airborne platform using a carrier frequency in a first frequency range, wherein said airborne platform is positioned at a predetermined altitude in the stratosphere, and wherein said platform is a single stage, turbocharged, piston-powered aircraft;
a second link for passing said signal between a second ground-based station and said airborne platform using a carrier frequency in a second frequency range; and
a means mounted on said airborne platform for converting carrier frequencies for said signal between said first frequency range and said second frequency range to interconnect said first link with said second link.

11. A system as recited in claim 10 wherein said predetermined altitude is approximately forty-one thousand feet.

12. A system as recited in claim 10 wherein said aircraft is a manned vehicle, and wherein said aircraft has a demand oxygen system and a turbocharger with a compression ratio of approximately 6.0:1.

13. A system as recited in claim 10 wherein said first frequency range includes radio (RF) frequencies between 1,850 MHz and 1,910 MHz, and wherein said second frequency range includes microwave (MW) frequencies between 3.7 GHz and 18 GHz.

14. A system as recited in claim 10 wherein said first link interconnects a system subscriber at said first ground-based station with a spot beam antenna on said airborne platform, and wherein said second link interconnects a base station with an airborne antenna mounted on said platform.

15. A system as recited in claim 14 wherein said converting means is a relay unit and comprises:
a stage for off-setting frequencies to match each said spot beam antenna on said platform with a transceiver; and
a control channel for varying a power level of said signal in said first frequency range to compensate for movement of said platform.

16. A system as recited in claim 15 wherein said base station comprises:
a stage for off-setting frequencies to match each said spot beam antenna on said platform with a transceiver at said base ground station; and
a control channel for making adjustments to frequencies in said second frequency range.

17. A method for transferring signals between ground-based stations which comprises the steps of:
positioning an airborne platform at a predetermined altitude in the stratosphere, wherein said platform is a single stage, turbocharged, piston-powered aircraft;
sending a signal over a first link between a first ground-based station and said platform using a carrier in a first frequency range;
passing said signal over a second link between said platform and a second ground-based station using a carrier in a second frequency range; and
transferring said signal between said first link and said second link at said airborne platform to establish communications between said first and second ground-based stations.

18. A method as recited in claim 17 wherein said positioning step is accomplished at an altitude of approximately forty-one thousand feet.

19. A method as recited in claim 17 further comprising the step of converting carrier frequencies for said signal between said first frequency range and said second frequency range during said transferring step.

20. A method as recited in claim 19 further comprising the steps of:
off-setting frequencies to match a spot beam antenna in said first link with a transceiver in said second link;
varying signals in said first frequency range to compensate for movement of said platform; and
making adjustments to frequencies in said second frequency range in response to said varying step.
